(19) United States
(12) Patent Application Publication
(10) Pub. No.: US 2006/0145372 A1
(43) Pub. Date: Jul. 6, 2006

(54) Optical tool assembly for improved RCW and lens edge formation

(76) Inventors: Thomas G. Jones, Rochester, NY (US); Bruce E. Lawton, Rochester, NY (US)

Correspondence Address: Bausch & Lomb Incorporated, One Bausch & Lomb Place, Rochester, NY, 14604-2701, US

(21) Appl. No.: 11/027,406

(22) Filed: Dec. 30, 2004

(51) Int. Cl. B29D 11/00

(52) U.S. Cl. 264/1.32; 264/2.5; 425/808

(57) ABSTRACT

An optical tool assembly for use in an injection molding apparatus opposite a non-optical tool assembly to form an ophthalmic mold section including a cavity ring mounted to an associated mold plate and an optical insert removeably secured to the cavity ring and having an optical molding surface thereon for forming an optical surface of the ophthalmic mold section. The optical molding surface has a right cylindrical wall (RCW) molding portion for forming a RCW of the ophthalmic mold section. The RCW molding portion is formed adjacent a peripheral edge of the optical insert.

### RELATED APPLICATION

This application is related to U.S. patent applications entitled “NON-OPTICAL MULTI-PIECE CORE ASSEMBLY FOR RAPID TOOL CHANGE” (Attorney Docket No. P03454), “CORE LOCKING ASSEMBLY AND METHOD FOR ORIENTATION OF ASYMMETRICAL TOOLING” (Attorney Docket No. P03455) and “OPTICAL TOOL ASSEMBLY” (Attorney Docket No. P03456); all filed concurrently herewith, commonly assigned to Bausch & Lomb Incorporated and expressly incorporated herein by reference.

### BACKGROUND

The present disclosure relates to the molding of articles of manufacture. More particularly, the disclosure relates to an improved optical tool assembly for injection molding mold sections or preforms having an improved right cylinder wall (RCW) which are used in the manufacture of ophthalmic lenses, including contact lenses and intraocular lenses, having an improved lens edge formation and will be described with particular reference thereto. It is to be appreciated, however, that the improved optical tool assembly and apparatus related thereto is adaptable for effective use in other environments and applications.

One method in practice for making ophthalmic lenses, including contact lenses and intraocular lenses, is cast molding. Cast molding of ophthalmic lenses involves depositing a curable mixture of polymerizable lens materials, such as monomers, in a mold cavity formed by two assembled mold sections, curing the mixture, disassembling the mold sections and removing the molded lens. Other post-molding processing steps, for example, hydration in the case of hydrogel lenses, may also be employed. Representative cast molding methods are disclosed in U.S. Pat. Nos. 5,271,875 (Appleton et al.); 4,197,266 (Clark et al.); 4,208,364 (Shepherd); 4,865,779 (Ihn et al.); 4,955,580 (Seden et al.); 5,466,147 (Appleton et al.); and 5,143,660 (Hamilton et al.).

When cast molding between a pair of mold sections, typically one mold section, referred to as the anterior mold section or preform, forms the anterior convex, optical surface of the ophthalmic lens and the other mold section, referred to as the posterior mold section or preform, forms the posterior concave, optical surface of the ophthalmic lens. The anterior and posterior mold sections are generally complimentary in configuration. They are joined together during the molding process to form a lens forming or molding cavity. Once the lens is formed, the mold sections or preforms are separated and the molded lens is removed. The anterior and posterior mold sections are usually used only once for casting a lens prior to being discarded due to the significant degradation of the optical surfaces of the mold sections that often occurs during a single casting operation.

Formation of the mold sections used in casting a lens occurs through a separate molding process prior to cast molding of the lens. In this regard, the mold sections are first formed by injection molding a resin in the cavity of an injection molding apparatus. More particularly, mounted in the injection molding apparatus are tools for forming the mold sections. Typically, the tools are fitted into mold plates in the injection molding machine and the mold sections are produced by injection molding a selected resin between opposed sets of injection molding tools. The tools are typically made from brass, stainless steel, nickel, or some combination thereof and, unlike the mold sections which are used only once, are used again and again to make large quantities of mold sections.

The injection molding tools are typically formed in accordance with the specification of the corresponding ophthalmic lens surfaces to be formed on or by the mold sections. That is, the ophthalmic lens being produced determines the specific design of the mold sections. The needed mold section parameters, in turn, determine the design of the corresponding injection molding tools. The injection molding tools are typically manufactured to extremely high specifications and/or tolerances so that no roughness or surface defects are transferred to the mold sections being made from the tools. Any such defects on the mold sections, particularly on an optical surface of a mold section, is likely to be transferred to, and appear on, the finished lens during the cast molding operation.

Each mold section, whether it be a posterior mold section or an anterior mold section, includes an optical surface (posterior optical surface on a posterior mold section and anterior optical surface on an anterior mold section) that forms a surface of the ophthalmic lens, as well as a non-optical surface. When injection molding the mold section, the injection molding apparatus typically includes an optical tool assembly having an optical molding surface for forming the optical surface of the mold section and a non-optical tool assembly for forming the non-optical surface of the mold section, which is opposite the optical surface. As is known to those skilled in the art, the optical molding surface can be changed for purposes of producing mold sections of different thicknesses, which are in turn used to produce ophthalmic lenses of varying powers.

Often, the anterior mold section includes a right cylinder wall (RCW) adjacent a periphery of its optical surface. The RCW of the anterior mold section is used to form the final edge of the ophthalmic lens produced by the mold section and is desirably controlled to tight tolerances. Heretofore, the RCW was formed by an optical tool insert being selectively positioned within a body. The optical tool insert included a primary molding surface for forming the optical surface of the mold section and a secondary, cylindrical mold surface for forming the RCW. Typically, shims were used to position the optical insert relative to the body until sufficient protrusion of the cylindrical molding surface was reached for forming the RCW.

The use of shims cause tool setup difficulties, including the need for numerous iterative attempts to achieve the desired protrusion of the optical tool relative to the body, which requires additional downtime of the injection molding machine in which the tool assembly is employed. Moreover, gaps often result between the tool insert and the body which manifests as plastic flash near the RCW when cast molding the lens. This ultimately leads to potentially fatal defects being contained within the ophthalmic lens. Any improvements to the optical tool assembly that would eliminate the need for shims and/or eliminate (or at least reduce) the occurrence of gaps which ultimately create flash are considered desirable, particularly those that reduce injection molding machine downtime.

### BRIEF SUMMARY

According to one aspect, an optical tool assembly is provided for use in an injection molding apparatus opposite a non-optical tool assembly to form an ophthalmic mold section. More particularly, in accordance with this aspect, the optical tool assembly includes a cavity ring mounted to an associated mold plate and an optical insert removeably secured to the cavity ring. The optical insert has an optical molding surface thereon for forming an optical surface of the ophthalmic mold section. The optical molding surface has a right cylindrical wall (RCW) molding portion for forming a RCW of the ophthalmic mold section. The RCW molding portion is formed adjacent a peripheral edge of the optical insert.

According to another aspect, an apparatus for injection molding an ophthalmic lens mold is provided and has an optical surface and a non-optical surface opposite the optical surface. More particularly, in accordance with this aspect, the apparatus includes a non-optical tool assembly for forming a non-optical surface of the ophthalmic lens mold and an optical tool assembly in opposed relation to the non-optical tool assembly that together therewith forms a mold cavity for forming the ophthalmic lens mold. The optical tool assembly includes a cavity ring and an optical tool insert. The cavity ring is removably secured to a mold plate of an injection molding apparatus. The optical tool insert has an optical molding surface thereon for forming the optical surface of the ophthalmic lens mold. The optical tool insert is removably secured to the cavity ring. A right cylindrical wall (RCW) molding portion of the optical molding surface is formed adjacent a peripheral edge of the optical molding surface. The RCW molding portion forms a T-shape with a cavity ring molding surface.

In accordance with yet another aspect, an injection molding apparatus is provided for forming a mold section which is subsequently used for forming an ophthalmic lens. More particularly, in accordance with this aspect, the injection molding apparatus includes a mold member mounted to an associated first mold plate. An optical tool insert is removably mounted to the mold member. The optical tool insert has a molding surface with an optical quality finish that includes a right cylindrical wall (RCW) forming a peripheral edge of the optical tool insert. A core member is mounted to an associated second mold plate opposite the associated first mold plate. A non-optical tool insert is removably mounted to the core member. The non-optical insert has a non-optical molding surface for forming a surface of the mold section opposite the optical surface.

In accordance with still yet another aspect, a method for forming an ophthalmic lens is provided. More particularly, in accordance with this aspect, an apparatus is provided for injection molding an ophthalmic lens mold section having an optical surface and a non-optical surface opposite the optical surface. The apparatus has a non-optical tool assembly for forming the non-optical surface of the ophthalmic lens mold section and an optical tool assembly in opposed relation to the non-optical tool assembly that together therewith forms a mold cavity for forming the ophthalmic lens mold section. The optical tool assembly includes a cavity ring removably secured to a mold plate of an injection molding apparatus and an optical tool insert having an optical molding surface thereon for forming the optical surface of the ophthalmic lens mold section. The optical tool insert is removably secured to the cavity ring. A right cylindrical wall (RCW) molding portion of the optical molding surface is formed adjacent a peripheral edge of the optical molding surface. The RCW molding portion forms a T-shape with a cavity ring molding surface. The ophthalmic lens mold section is injection molded in the mold cavity. The ophthalmic lens mold section is removed from the cavity. The ophthalmic lens mold section is matched to a mating ophthalmic lens mold section. An ophthalmic lens is cast molded between the ophthalmic lens mold section.

### BRIEF DESCRIPTION OF THE DRAWINGS

FIG. 1 is a schematic exploded view of a representative mold section assembly forming an ophthalmic lens.

FIG. 2 is a schematic cross-sectional view of the mold section assembly of FIG. 1 showing mating mold sections in nesting relation.

FIG. 2a is an enlarged, partial, schematic cross-sectional view of the mold sections of FIG. 2.

FIG. 3 is a schematic cross-sectional view of an injection molding arrangement having tool assemblies (including an optical tool assembly and a non-optical tool assembly) for injection molding an anterior mold section of the mold assembly shown in FIGS. 1 and 2.

FIG. 4 is an enlarged partial view of the optical tool assembly of FIG. 3.

FIG. 5 is a rear perspective view of an optical tool insert of the optical tool assembly of FIG. 4.

FIG. 6 is a front perspective view of the optical tool insert of the optical tool assembly of FIG. 4.

FIG. 7 is a side elevational view of the optical tool insert of the optical tool assembly of FIG. 4.

FIG. 7a is an enlarged partial elevational view of the optical tool insert of FIG. 7.

### DETAILED DESCRIPTION

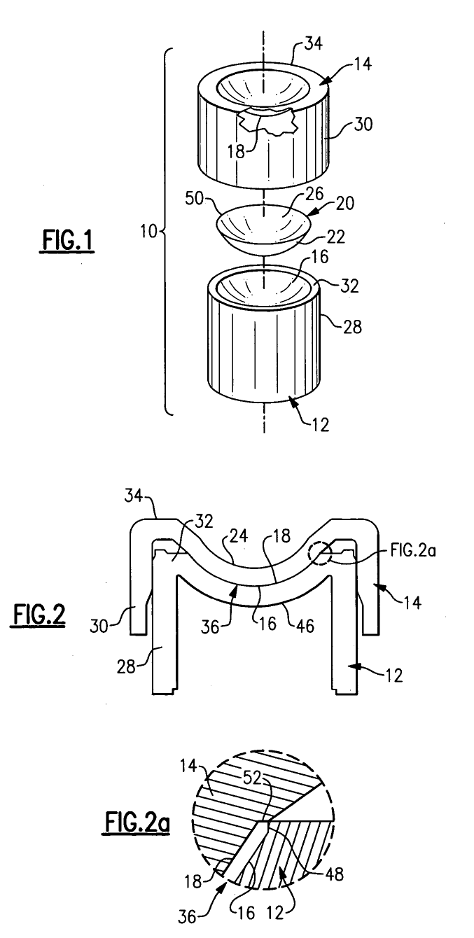

Referring now to the drawings wherein the showings are for purposes of illustrating one or more embodiments and not for purposes of limiting the same, a representative mold assembly is shown in FIG. 1 and generally designated by reference numeral 10. The mold assembly 10 includes an anterior mold preform or section 12 and a posterior mold preform or section 14. When the mold sections 12 and 14 are assembled, optical surfaces 16,18 of the mold sections 12,14 define a mold cavity in which an ophthalmic lens 20 is formed, such as by cast molding. The ophthalmic lens 20 can be, for example, a contact lens or intraocular lens. The optical surface 16, also referred to herein as an anterior molding surface, is a concave surface that forms a convex, anterior side 22 of the lens 20 and the optical surface 18, also referred to herein as a posterior molding surface, is a convex surface formed opposite non-optical surface 24 that forms a concave, posterior side 26 of the lens 20. In the illustrated mold assembly 10, with additional reference to FIG. 2, mold sections 12,14 additionally include respective cylindrical walls 28,30 and segment walls 32,34 that nest (but not necessarily touch or contact one another) when the mold sections are fully assembled.

As will be described in more detail below, each of the mold sections 12,14, also referred to herein as ophthalmic lens molds, can be injection molded from a plastic resin, such as polypropylene, polyvinyl chloride (PVC) or polystyrene, for example, in a full injection molding apparatus. As will be understood by those skilled in the art, the injection molded sections 12,14 can then be used together as shown in FIG. 2 in a cast molding process wherein a curable lens material, such as a liquid polymerizable monomer mixture, is introduced onto the anterior molding surface 16, mold sections 12,14 are brought into close association with the liquid being compressed to fill lens mold cavity 36 formed between the mold sections 12,14, and the monomer mixture is cured into an ophthalmic lens, such as contact lens 20 shown in the illustrated embodiment. It should be readily appreciated by those skilled in the art that modified mold sections could be formed and applied in the above-described cast molding process to produce any type of lenses, such as, for example, spherical, toric, multifocal lenses and intraocular lenses.

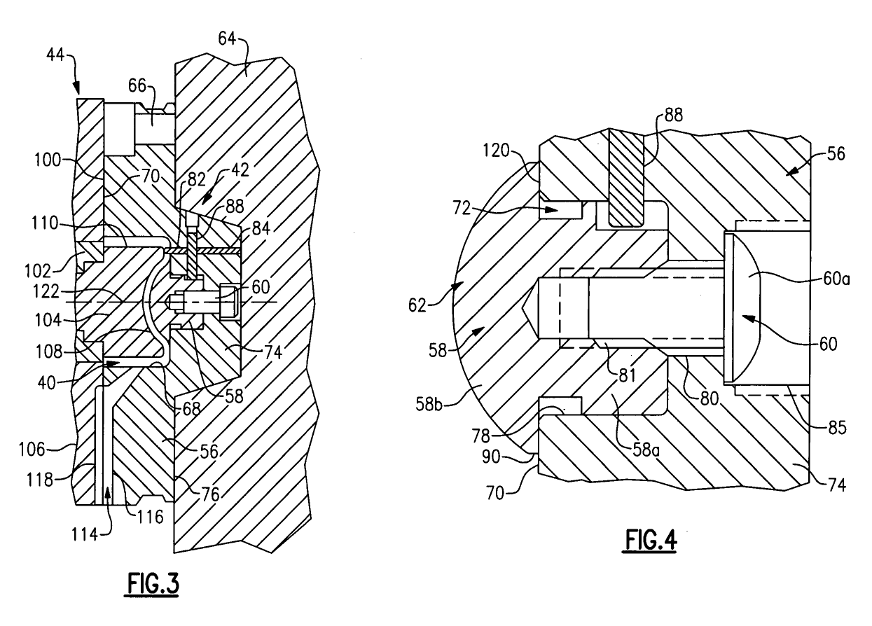

As will be understood by those skilled in the art, tool assemblies are mounted in the injection molding apparatus for forming the mold sections 12,14 by injection molding. The tool assemblies are mounted to and/or fitted into mold plates of the injection molding apparatus and the mold sections 12,14 are formed by injection molding a selected resin in a cavity formed between opposed sets of tool assemblies. With additional reference to FIG. 3, only tool assemblies for forming the anterior mold section 12 will be described in further detail herein.

In FIG. 3, mold section mold cavity 40 is formed between opposed tool assemblies, including optical tool assembly 42 and non-optical tool assembly 44, in which the mold section 12 can be formed. As illustrated, the optical tool assembly 42 forms the optical surface 16 of the mold section 12 and the non-optical tool assembly 44 forms non-optical surface 46 (FIG. 2) on an opposite side of the surface 16. The tool assemblies 42,44 also combine to form the cylindrical wall 28 and the segment wall 32.

With reference to FIG. 2a, the anterior mold section 12 includes a right cylinder wall (RCW) 48 formed at a periphery of the optical surface 16 adjacent the segment wall 32. In the cast molding process, the RCW 48 forms a final edge 50 (FIG. 1) of the lens 20. More specifically, the RCW forms a slight taper along the lens edge 50 which enhances the comfort of the lens 20 for a wearer thereof. Without the RCW, the lens edge 50 would have a significantly larger edge profile which could lead to discomfort for the wearer. In the illustrated embodiment, the posterior mold section 14 includes a tapered surface 52 between optical surface 18 and segment wall 34 which combines with the RCW 48 of the anterior mold section 12 to form lens edge 50 as a beveled edge. The beveled edge 50 reduces sharp angles at the periphery of the lens 20 allowing the lens to better float in a user's eye and help keep the eye free of undesirable deposit build-up.

The optical tool assembly 42 includes a mold member, which in the illustrated embodiment is cavity ring 56, and an optical tool insert 58 mounted to the cavity ring. The optical tool insert 58 is removably secured to the cavity ring 56 by a suitable fastener, such as a threaded member or cap screw 60. With further reference to FIG. 4, the optical tool insert 58 includes optical molding surface 62 which has an optical quality finish to form the anterior molding optical surface 16. As used herein, the term “optical quality finish” denotes a molding surface that is sufficiently smooth for forming optical surface 16 which ultimately forms the anterior side 22 of the ophthalmic lens 20. By having a optical quality finish, the lens 20 produced by the anterior molding surface 62 is suitable for placement in one's eye without the need to machine or polish the formed lens surface 22.

As will be appreciated by those skilled in the art, the insert 58 can be one of a set or series of inserts (not shown) and the removeability of the insert 58 enables it to be readily changed with another insert from the set of inserts. Each of the inserts in the set can have a different optical molding surface for purposes of ultimately molding lenses having differing optical powers. The cavity ring 56 is removeably secured to a mold plate 64 of the injection molding apparatus. Fasteners, such as threaded members or cap screws 66, are used to releaseably secure the cavity ring 56 to the mold plate 64 and to maintain the position of the cavity ring during injection molding of the mold section 12.

With continued reference to FIGS. 3 and 4, the optical tool insert 58 is received in a recess 68 defined in a front surface 70 of the cavity ring 56 and a shaft portion 58a of the insert 58 is received within another recess 72 defined in a central protuberance 74 extending from a rear side 76 of the cavity ring. Recess 68 also forms a cavity ring molding surface that forms a portion of the mold section 12. In the illustrated embodiment, this portion is an outer surface of the cylindrical wall 28 and the segment wall 32 of the mold section 12. As already indicated, the screw 60 removeably secures the insert 58 to the cavity ring 56. A head portion 58b of the insert 58 protrudes into the recess 68 and includes the optical molding surface 62 that forms the optical surface 16 of the mold section. More specifically, the screw 60 is received in a throughhole 80 defined centrally through the protuberance 74 and threadedly engaged to the insert 58 in a threaded bore 81 defined in the shaft portion 58a. A head 60a of the screw 60 is received in counterbore 85.

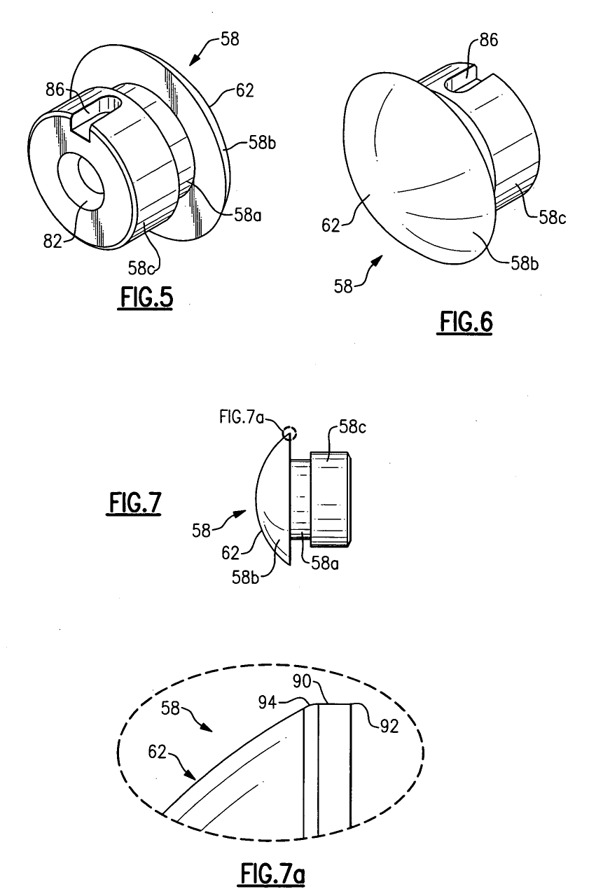

A molding dowel 82 extends into the mold cavity 40 from dowel bore 84 defined in the cavity ring 56. The molding dowel 82 marks the mold section 12 with an indent (not shown) in the segment wall 32 to record the rotational orientation of the mold section 12 in the mold cavity 40. With additional reference to FIGS. 5 and 6, the shaft portion 58a includes a radially extending portion 58c which is spaced from the head portion 58b. An axially extending recess 86 is defined in the portion 58c which receives a dowel member 88 extending radially from the cavity ring 56 into the recess 72. Cooperation between the dowel 88 and the recess 86 rotatably aligns the insert 58 relative to the cavity ring 56 to orient any non-rotationally symmetrical feature on insert 58 in a prescribed orientation relative to the remaining mold parts.

With still additional reference to FIGS. 7 and 7a, the insert 58 includes an RCW molding surface 90 formed adjacent a peripheral edge 92 of the molding surface 62 of the insert 58. The RCW portion 90, also referred to herein as an RCW molding surface, forms the RCW 48 in mold section 12 shown in FIGURE 2a. The RCW molding surface 90 extends axially relative to the insert 58 and is generally parallel to a mold cavity axis 122. A curved junction portion 94 connects or transitions the RCW portion 90 to the rest of the molding surface 62. The RCW portion 90 and the junction portion 94 allow the insert 58 to be installed in the cavity ring 56 without the use of shims, thus enabling the insert 58 to be installed in a single setup step (i.e., no iterative setup steps are required for setting up the RCW molding surface). The RCW molding portion 90 terminates into the cavity ring molding surface 70. The RCW molding portion 90 is oriented approximately normal relative to the cavity ring molding surface 70, which flanks the RCW surface 90 and no gap is formed between the RCW molding portion 90 and surface 70 so flash is reduced or eliminated. The RCW molding portion 90 forms a T-shape with the cavity ring molding surface 70.

Though the illustrated embodiment shows the optical insert 58 directly secured to the cavity ring 56, it is to be appreciated that other alternate arrangements are possible and are to be considered within the scope of the present invention. For example, the cavity ring can be formed of two parts: an outer cavity ring and an inner body member. In this arrangement, the insert 58 is secured by the fastener 60 to the body member and the body member is slidably received in a central opening of the cavity. Such an arrangement could enable faster insert changes. More details of such an arrangement are provided in commonly assigned, copending U.S. patent application entitled “Optical Tool Assembly,” filed concurrently herewith and expressly incorporated herein by reference.

As illustrated, with specific reference back to FIG. 3, the cavity ring 56 mates with the non-optical tool assembly 44 along a parting line 100 to form the closed mold cavity 40. In one embodiment, the non-optical tool assembly 44 includes a core member 102, a non-optical insert or cap 104 and a stripper member 106 (which can be a stripper plate or sleeve, for example) annularly received about the core member. The non-optical insert 104 includes a first molding surface 108 that forms the surface 46 opposite the optical surface 16 of the molding section 12 and a second molding surface 110 that forms an inner surface of the cylindrical wall 28 and an inner surface of the segment wall 32. The non-optical insert 104 is removeably secured to the core member 102 which can be conventionally secured to the injection molding apparatus. Of course, as would be apparent to one skilled in the art, the exact design or configuration to accommodate the molding assembly 44, as well as the molding assembly 42, will depend on the injection molding apparatus.

In one embodiment the insert 58 and the cavity ring 56 of the optical tool assembly 42 are formed of brass, stainless steel, nickel, or some combination thereof. The molding surfaces 62,68, can be formed according to methods generally known to those skilled in the art, such as, for example, lathe cutting or electrodischarge machining. The optical molding surface 62 (including RCW and junction molding portions 90,94) can additionally be polished to achieve precision surface quality so that no, or only insignificant, surface imperfections are transferred to the mold section 12. On the non-optical tool assembly 44, the core member 102 can be formed of a highly thermal conductive material such as beryllium copper (BeCu), while the insert 104 can be formed of a material that is more desirable to machine from an environmental/biohazards standpoint, such as copper, nickel or tin alloys. The molding surfaces 108,110 can be formed according to generally known methods such as lathe cutting or electrodischarge machining. The non-optical insert molding surface 108, used to form the non-optical surface 46 opposite the optical surface 16, does not require an optical quality finish as it does not contact the polymerizable lens mixture in the lens casting process. Thus, the surface 108 does not require the same degree of polishing as the optical molding surface 62 which is used to form the optical surface 16. However, some polishing or grinding may still be required.

A runner or sprue 114 is disposed between the tooling assemblies 42,44 and fluidly connects to the cavity 40 for allowing molten resin to be injected into the cavity 40 when injection molding the mold section 12. In the illustrated embodiment, the runner 114 connects to the cavity 40 along a portion thereof that forms the cylindrical wall 28 and thereby does not interfere with the molding of the optical surface 16. The runner 114 is formed by a first channel 116 defined in the cavity ring 56 and a second channel 118 defined in a stripper member 106, which is aligned with the first channel 116.

A parting line interface 120 between the insert 58 and the cavity ring 56 (more particularly, between the molding surface 62 and the first surface 70) is oriented along a plane that is approximately normal or perpendicular relative to draw experienced in the molding process. In particular, the interface 120 is formed between head 58b of insert 58 and surface 70 of the cavity ring 56. The interface 120 is oriented approximately normal relative to mold cavity axis 122. In the illustrated mold cavity 40, the direction of the draw will be substantially parallel to mold cavity axis 122. As a result, the portion of the mold section 12 formed by the RCW molding surface 90 can be formed completely free, or with at least significantly less, flash. In the event that flash is formed between the insert head portion 58b and the cavity ring 56, when the tool assemblies 42,44 are separated, the flash should likewise become separated from the molded mold section 12.

Positioning the RCW molding surface 90 adjacent the peripheral edge 92 of the insert 58 has the additional advantage of improving the squareness (as opposed to the previously observed occasional rounding) molded on the mold section 12 adjacent the RCW 48. This has the effect of producing a more uniform and repeatable mold section 12, particularly the portion of which that is molded by the RCW surface 90 which translates directly into a lens edge 50 of improved quality. Thus, the insert 58 with the RCW surface 90 adjacent the periphery edge 92 has the effect of reducing the cost of manufacturing by reducing setup time, as well as improving the final part quality of the molded lens 20.

The exemplary embodiment has been described with reference to one or more embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An optical tool assembly for use in an injection molding apparatus opposite a non-optical tool assembly to form an ophthalmic mold section, comprising:
a cavity ring mounted to an associated mold plate; and
an optical insert removably secured to said cavity ring and having an optical molding surface thereon for forming an optical surface of the ophthalmic mold section, said optical molding surface having a right cylindrical wall molding portion for forming a right cylindrical wall of the ophthalmic mold section, said right cylindrical wall molding portion formed adjacent a peripheral edge of said optical insert.

2. The optical tool assembly of claim 1 wherein said right cylindrical wall molding portion is generally parallel to a mold cavity axis.

3. The optical tool assembly of claim 1 wherein said optical molding surface includes a curved junction portion transitioning said right cylindrical wall molding portion to a remainder of said optical molding surface.

4. The optical tool assembly of claim 1 wherein said cavity ring includes a cavity ring molding surface that forms a mold section portion of the ophthalmic mold section surrounding said optical surface.

5. The optical tool assembly of claim 4 wherein said mold section portion includes at least one of said segment wall outer surface and said cylindrical wall outer surface.

6. The optical tool assembly of claim 4 wherein said right cylindrical wall molding portion terminates into said cavity ring molding surface.

7. The optical tool assembly of claim 4 wherein a parting line interface is formed between a head of said optical insert and said cavity ring molding surface, said parting line interface oriented approximately normal relative to molding cavity axis.

8. The optical tool assembly of claim 1 wherein said right cylindrical wall molding portion is oriented approximately normal relative to said cavity ring molding surface which flanks said right cylindrical wall molding surface.

9. The optical tool assembly of claim 1 wherein substantially no gap is formed between said right cylindrical wall molding portion and a molding surface of said cavity ring that forms an outer segment surface of the ophthalmic mold section.

10. The optical tool assembly of claim 1 wherein said optical tool insert is received within a recess defined in said cavity ring, a surface defining said recess forms an optical tool assembly molding surface for forming outer surfaces of said ophthalmic lens mold, and a head portion of said optical tool insert protrudes into said recess and includes said optical molding surface thereon.

11. The optical tool assembly of claim 10 wherein said right cylindrical wall molding portion is disposed on said head portion adjacent a peripheral edge of said head portion.

12. The optical tool assembly of claim 11 wherein said head portion includes a shoulder that abuts said optical tool assembly molding surface.

13. An apparatus for injection molding an ophthalmic lens mold having an optical surface and a non-optical surface opposite the optical surface, comprising:
a non-optical tool assembly for forming the non-optical surface of the ophthalmic lens mold;
an optical tool assembly in opposed relation to said non-optical tool assembly that together therewith forms a mold cavity for forming the ophthalmic lens mold, said optical tool assembly includes:
a cavity ring removably secured to a mold plate of an injection molding apparatus, said cavity ring having a cavity ring molding surface;
an optical tool insert having an optical molding surface thereon for forming the optical surface of the ophthalmic lens mold, the optical tool insert removably secured to said cavity ring; and
a right cylindrical wall molding portion of said optical molding surface formed adjacent a peripheral edge of said optical molding surface, said right cylindrical wall molding portion extending substantially perpendicular to said cavity ring molding surface.

14. The apparatus at claim 13 wherein said cavity ring molding surface forms a segment wall of the ophthalmic lens mold.

15. The apparatus of claim 13 wherein a parting line interface is formed between said optical tool insert and said cavity ring that is oriented substantially perpendicular relative to the direction of draw when removing said ophthalmic lens mold from said non-optical tool assembly.

16. The apparatus of claim 13 wherein said right cylindrical wall molding portion is formed adjacent a peripheral edge of said optical insert.

17. The apparatus of claim 13 wherein said non-optical tool assembly includes:
a core member having a cooling cavity with a cooling medium therein for cooling the ophthalmic lens mold after injection molding, said core member removably secured to a second mold plate of said injection molding apparatus;
a non-optical insert removably secured to said core member at a location spaced from said cooling cavity, said non-optical insert having a first molding surface for forming a surface of the ophthalmic lens mold opposite the optical surface; and
a stripper member annularly disposed on said core member and positioned to forcibly remove the ophthalmic lens mold from said non-optical insert after injection molding thereof upon advancement of said stripper member.

18. The apparatus of claim 17 wherein said cavity ring and said stripper member define a runner fluidly connected to said mold cavity for allowing molten resin to be injected into said mold cavity when injection molding the ophthalmic lens mold.

19. An injection molding apparatus for forming a mold section which is subsequently used for forming an ophthalmic lens, comprising:
a mold member mounted to an associated first mold plate;
an optical tool insert removably mounted to said mold member, said optical tool insert having a molding surface with an optical quality finish that includes a right cylindrical wall forming a peripheral edge of said optical tool insert;
a core member mounted to an associated second mold plate opposite the associated first mold plate; and
a non-optical tool insert removably mounted to said core member, said non-optical insert having a non-optical molding surface for forming a surface of the mold section opposite the optical surface.

20. The injection molding apparatus of claim 19 wherein said mold member, said optical insert and said non-optical insert together form a mold cavity shaped to mold the mold section.

21. A method for forming an ophthalmic lens, comprising the steps of:
providing an apparatus for injection molding an ophthalmic lens mold having an optical surface and a non-optical surface opposite the optical surface, wherein the apparatus comprises:
a) a non-optical tool assembly for forming the non-optical surface of the ophthalmic lens mold and an optical tool assembly in opposed relation to the non-optical tool assembly that together therewith forms a mold cavity for forming the ophthalmic lens mold;
b) the optical tool assembly including a cavity ring removably secured to a mold plate, said cavity ring having a cavity ring molding surface;
c) an optical tool insert having an optical molding surface thereon for forming the optical surface of the ophthalmic lens mold, the optical tool insert removably secured to the cavity ring; and
d) a right cylindrical wall molding portion of the optical molding surface formed adjacent a peripheral edge of the optical molding surface, the right cylindrical wall molding portion extending substantially perpendicular to said cavity ring molding surface;
wherein said method comprises the steps of:
a) injection molding the ophthalmic mold section in the mold cavity;
b) removing the molded ophthalmic mold from the mold cavity;
c) matching the ophthalmic mold section with a mating ophthalmic mold section; and
d) cast molding an ophthalmic lens between the ophthalmic mold sections.

22. An ophthalmic lens formed according to the method of claim 21.
